(19) United States
(12) Patent Application Publication
(10) Pub. No.: US 2010/0241958 A1
(43) Pub. Date: Sep. 23, 2010

(54) METHOD AND SYSTEM TO MANAGE AND PRIORITIZE WINDOWS BASED ON TOUCH STRIP INPUTS

(76) Inventor: Ram David Adva Fish, Menlo Park, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/730,199

(22) Filed: Mar. 23, 2010

Related U.S. Application Data
(60) Provisional application No. 61/210,862, filed on Mar. 23, 2009.

(51) Int. Cl. G06F 3/01; G06F 3/048

(52) U.S. Cl. 715/702; 345/173; 715/781; 715/769; 715/788

(57) ABSTRACT

Method and system for managing and prioritizing windows based on touch strip inputs. A method may include detecting a user gesture on a touch strip positioned on a screen, where the screen has multiple regions, and each region is associated with a set of applications. The method further includes identifying at least one of the regions that corresponds to the user gesture, determining which action should be performed with respect to at least one application associated with the identified region, and performing the action with respect to the at least one application associated with the identified region.

### RELATED APPLICATION

This application is related to and claims the benefit of U.S. Provisional Patent application Ser. No. 61/210,862, filed Mar. 23, 2009 which is hereby incorporated by reference.

### FIELD OF THE INVENTION

Embodiments of the present invention relate generally to data display; and more particularly to managing and prioritizing windows based on touch strip inputs.

### BACKGROUND OF THE INVENTION

The increased processing power of computers allows users to perform multiple tasks simultaneously. Such multitasking can occur in a single application (e.g., launching multiple instances of a web browser) or across multiple applications. In window-based operating systems, each currently running application may have one or more windows open to execute tasks desired by the user. Hence, the user may have a significant number of windows (e.g., 10-15 windows) opened at the same time. Navigation between such a large number of windows can be confusing and disruptive.

### BRIEF DESCRIPTION OF THE DRAWINGS

The present invention is illustrated by way of example, and not by way of limitation, and can be more fully understood with reference to the following detailed description when considered in connection with the figures in which:

FIG. 1 is a block diagram of one embodiment of a system for managing windows on a display screen.

FIG. 2 is a block diagram of one embodiment of a window manager, which may be the same as window manager.

FIG. 3 is a flow diagram of one embodiment of a method for managing windows on a display screen.

FIG. 4 illustrates a configuration of an exemplary display screen, in accordance with some embodiments.

FIG. 5 illustrates an exemplary computer system within which embodiments of the invention may be implemented.

### DETAILED DESCRIPTION

Method and system for managing and prioritizing windows based on touch strip inputs are described herein. The system includes a display screen that has multiple regions and a touch strip. By detecting a user gesture on the touch strip, various actions can be performed with respect to applications associated with specific regions. As will be discussed in more detail below, application windows can be automatically arranged, flipped through and selected by the user, by leveraging the touch strip to control the interaction. The touch strip provides a convenient mechanism for gathering user inputs without cluttering the display with navigation icons or information, and therefore simplifies the interactions and provides consistent experience regardless of the information displayed.

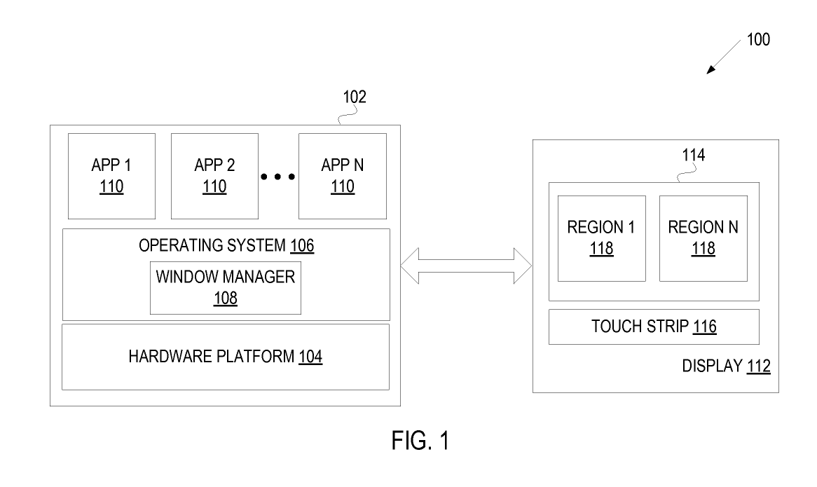

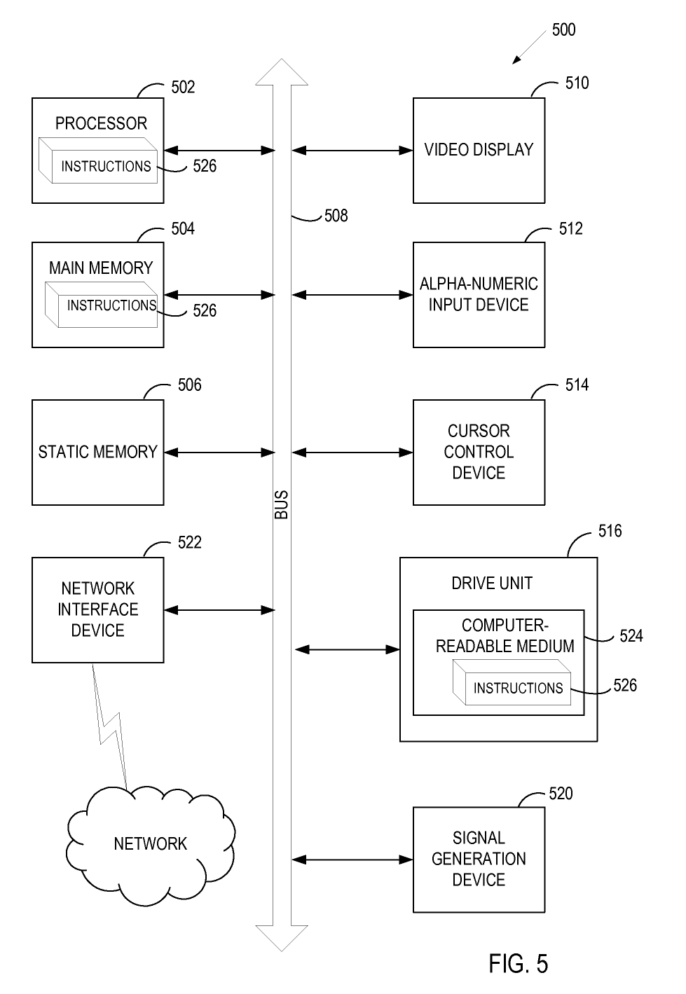

FIG. 1 is a block diagram of one embodiment of a system 100 for managing windows on a display screen. The system 100 includes a computer system 102 that has a hardware platform (e.g., processor, memory, etc.) 104 and a display device 112. The computer system 102 may be a desktop computer, a server computer, a personal computer, a notebook, a tablet, an appliance, or any other computing device. An exemplary computer system will be discussed in more detail below in conjunction with FIG. 5.

The computer system 102 includes an operating system 106 running on the hardware platform 104 and facilitating the execution of multiple applications 110. Each executing application 110 may have one or more windows open on the display device 112 to perform tasks desired by a user. In one embodiment, the operating system 106 includes a window manager 108 that manages and prioritizes the presentation of the application windows on the screen of the display device 112. The screen of the display device 112 includes a display area 114 and a touch strip 116. The touch strip 116 is a touch sensitive area, which can be either a stand alone touch area separate from the display 114 or a dedicated part of the display 114. The display area 114 may or may not be a touch screen area, depending on the type of the display device 112. The display area 114 includes multiple regions 118. Each application 110 may be allocated to one or more regions 118 using queues (e.g., round robin queues) associated with individual regions 118.

As shown, the regions 118 may be positioned in the display area 114 horizontally, with the touch strip 116 located above or below the regions 118. Alternatively, the regions 118 may be positioned in the display area 114 vertically, with the touch strip 116 located on either side of the regions 118. The touch strip 116 is divided to correlate to the regions 118 allocated on the display 112. The user may provide various inputs on the touch strip 116. For example, the user input may include tapping, sliding, double tapping, and the like.

The window manager 108 detects the user gesture on the touch strip 116, identifies which of the regions 118 corresponds to the user gesture, and determines which action should be performed in response to the user gesture. For example, if the user taps on a touch strip area associated with the first region, the window manager 108 may change the currently active application in the first region to the next application in the queue of the first region. Alternatively, if the user slides from the touch strip area associated with the first region to the touch strip area associated with the second region, the window manager 108 may move the currently active application in the first region to an active application in the second region. Yet alternatively, if the user slides from the touch strip area associated with the first region to the near end of the touch strip, the window manager 108 may close the currently active application in the first region and select the next application in the queue of the first region as active. Still alternatively, if the user double taps in the touch strip area associated with the first region, the window manager 108 may cause the first region to be displayed in the full screen mode.

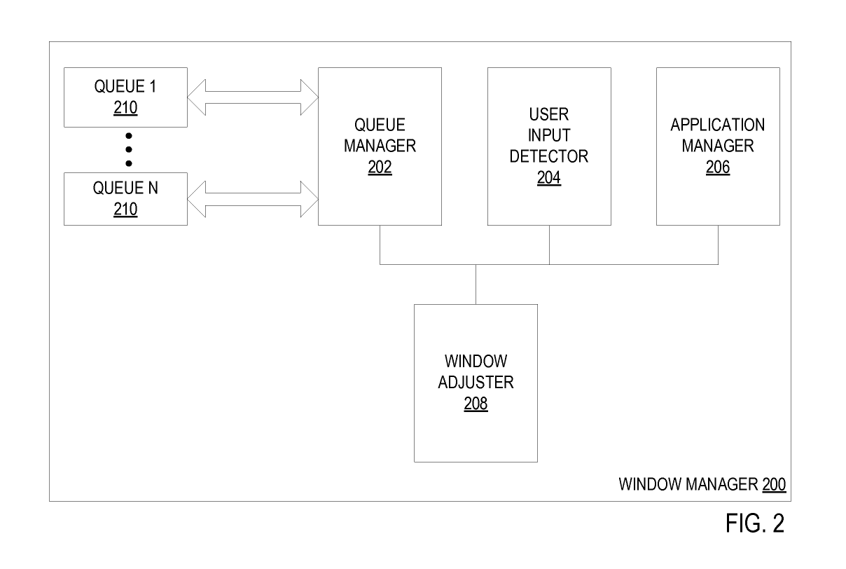

FIG. 2 is a block diagram of one embodiment of a window manager 200, which may be the same as window manager 108. The window manager 200 may include a queue manager 202, a user input detector 204, an application manager 206 and a window adjuster 208.

The queue manager 202 may maintain different round robin queues 210 for individual regions on a display area (e.g., display area 114). The queue manager 202 allocates applications invoked by the user to the queues 210 based on user input or applications signaling events or predefined parameters.

The user input detector 204 detects a user gesture on the touch strip, identifies a region associated with the gesture based on the location of the user gesture on the touch strip, and determines what action should be performed with respect to one or more applications in the identified region, based on the user gesture. In one embodiment, a table is maintained that ties a user gesture to a specific action.

The application manager 206 performs various actions with respect to relevant applications (e.g., moving an application to a different region, closing an application, changing a currently active application in the region, etc.). The window adjuster 208 changes the display characteristics of the region when the user gesture requires such a change (e.g., changing the display of a region to a full screen mode, highlighting the region, etc.).

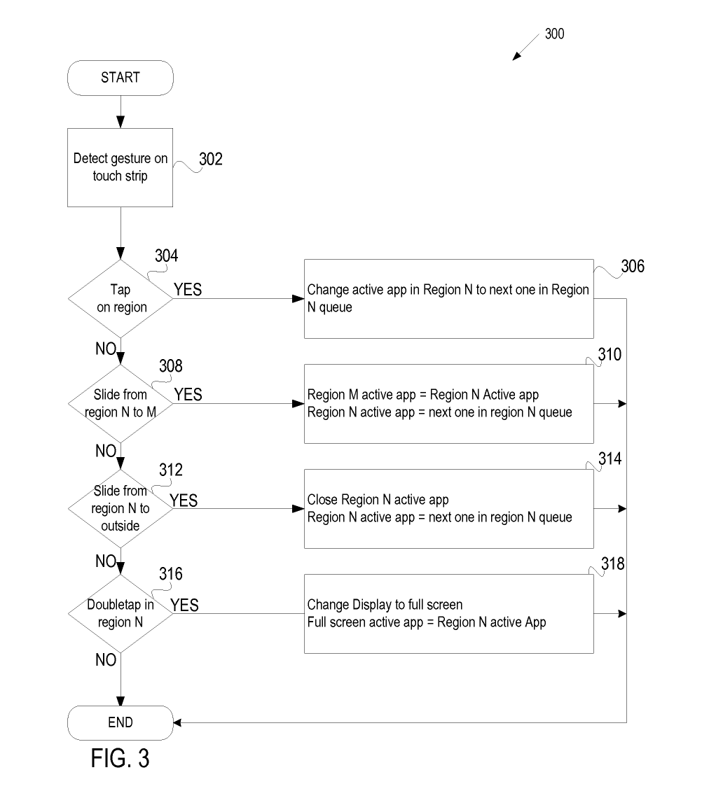

FIG. 3 is a flow diagram of one embodiment of a method 300 for managing windows on a display screen. The method 300 is performed by processing logic that may comprise hardware (circuitry, dedicated logic, etc.), software (such as is run on a general purpose computer system or a dedicated machine), or a combination of both. In one embodiment, the method 300 is performed by computer system 100 (e.g., a window manager 108 running on the computer system 100).

Referring to FIG. 3, processing logic begins by detecting a user gesture on a touch strip, and identifying a display region N pertaining to the user gesture based on the location of the user gesture on the touch strip (block 302). At block 304, processing logic determines whether the user gesture includes a tap on the touch strip area associated with region N. If so, processing logic changes the currently active application in region N to the next application in the queue of region N (block 306).

If the user gesture is a slide from region N to region M (block 308), processing logic moves the currently active application in region N to region M as a currently active application, and makes the next application in the queue of region N active (block 310). If the user gesture is a slide from region N toward the near end of the touch strip (block 312), processing logic closes the currently active application in region N, and makes the next application in the queue of region N active (block 312). If the user gesture is a double tap in region N (block 316), processing logic changes the display of region N to the full screen mode, keeping the same active application whose window is now displayed in the full screen mode.

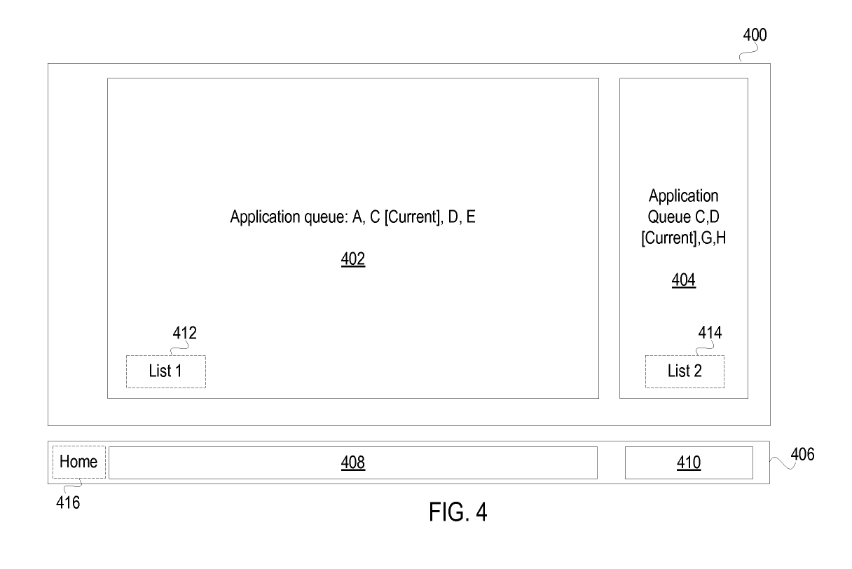

FIG. 4 illustrates a configuration of an exemplary display screen, in accordance with some embodiments. The display screen includes a display area 400 and a touch strip 406. The display area 400 is divided into two regions 402 and 404. X range of the touch strip 406 is divided into areas 408 and 410 to correlate to the regions 402 and 404 allocated on the physical display. Select operation may be defined as either touching down for a minimal duration, touch and letting go after a minimal duration

Applications can be allocated to either of the window regions or to both. Therefore, two round robin queues are maintained: one of applications that can be displayed on region 402 and one queue for applications that can be displayed in region 404. When a user “selects” a region, the window manager rotates the application displayed within the region, without affecting the window displayed in the other region. For example, by selecting area 410 on the touch strip 406, the user causes the display in region 404 to switch from application C to application D.

In some embodiments, if the touch strip 406 supports both X and Y axis, Y axis motion can be detected and defined as Select Up or Select DN, allows the user to select displaying either the applications which is up or down the queue.

In one embodiment, if a user wants to move an application from one region to the other, the user may slide their finger from area 410 to area 408. For example, if application D is displayed in region 404, and the user slides the finger from area 410 to area 408, application D will become active (displayed) in region 402, and region 404 will display the next application in the queue (application G).

In one embodiment, sliding a finger from a touch strip area toward the near end of the touch strip 406 can be used as a signal to close the application currently displayed. For example, if the user slides from touch strip area 410 to the right, this is interpreted as a signal to close application D.

In one embodiment, a slow slide within a touch strip area (e.g., a slide rightward in area 408) may be interpreted as a signal to automatically rotate the applications within the region. For example, the window manage may change windows every predefined time interval (e.g., 500 msec) until the user stops touching the touch strip 406. In one embodiment, double tapping in a touch strip area may be used to signal that the user wants to maximize the application usage of the screen, and therefore regions 402 and 404 may be temporarily merged and the application can utilize the full screen.

In some embodiments, regions 402 and 404 display optional lists 412 and 414 that identify applications in respective queues in the order of priority. In one embodiment, the touch strip 406 includes an optional area 416 that can be dedicated to special functions (e.g., correlating to a “Home Screen” key, which upon selection can immediately activate the home application in one or both regions based on user preferences).

FIG. 5 illustrates an exemplary computer system 500 within which a set of instructions, for causing the computer system to perform any one or more of the methodologies discussed herein, may be executed. In alternative embodiments, the computer system may be connected (e.g., networked) to other machines in a LAN, an intranet, an extranet, or the Internet. The computer system may operate in the capacity of a server or a client machine in client-server network environment, or as a peer machine in a peer-to-peer (or distributed) network environment. The computer system may be a personal computer (PC), a tablet PC, a set-top box (STB), a Personal Digital Assistant (PDA), a cellular telephone, a notebook, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a data storage device 518, which communicate with each other via a bus 506.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute the processing logic 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a computer-readable medium 524 on which is stored one or more sets of instructions (e.g., software 526) embodying any one or more of the methodologies or functions described herein. The software 526 may also reside, completely or at least partially, within the main memory 504 and/or within the processor 502 during execution thereof by the computer system 500, the main memory 504 and the processor 502 also constituting computer-readable media. The software 526 may further be transmitted or received over a network 520 via the network interface device 522.

While the computer-readable medium 524 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, optical media, and magnetic media.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
detecting a user gesture on a touch strip positioned on a screen, the screen having a plurality of regions and the touch strip, each region associated with a set of applications;
identifying at least one of the plurality of regions corresponding to the user gesture;
determining, based on the user gesture, which action is to be performed with respect to at least one application associated with the identified region; and
performing the action with respect to the at least one application associated with the identified region.

2. The method of claim 1 wherein the touch strip is positioned below the plurality of regions and has multiple areas, each area associated with a distinct one of the plurality of regions.

3. The method of claim 2 wherein:
the user gesture is a tap on a touch strip area associated with a first region; and
the action to be performed comprises changing an active application in the first region to a next application in a queue of the first region.

4. The method of claim 2 wherein:
the user gesture is a slide from a touch strip area associated with a first region to a touch strip area associated with a second region; and
the action to be performed comprises moving an active application from the first region to an active application in the second region.

5. The method of claim 2 wherein:
the user gesture is a slide from a touch strip area associated with a first region to a near end of the touch strip; and
the action to be performed comprises closing an active application in the first region and selecting a next application in a queue of the first region as active.

6. The method of claim 2 wherein:
the user gesture is a double tap in a touch strip area associated with a first region; and
the action to be performed comprises displaying the first region in a full screen mode.
